(19) United States
(12) Patent Application Publication
(10) Pub. No.: US 2008/0022404 A1
(43) Pub. Date: Jan. 24, 2008

(54) Anomaly detection

(75) Inventors: Silke Holtmanns, Klaukkala (FI); Markus Miettinen, Vantaa (FI)

Correspondence Address: SQUIRE, SANDERS & DEMPSEY L.L.P., 14TH FLOOR, 8000 TOWERS CRESCENT, TYSONS CORNER, VA, 22182, US

(73) Assignee: Nokia Corporation

(21) Appl. No.: 11/544,592

(22) Filed: Oct. 10, 2006

(30) Foreign Application Priority Data
Jul. 7, 2006 (FI) 20060665

(51) Int. Cl. G06F 12/14

(52) U.S. Cl. 726/23

(57) ABSTRACT

A method for improving application security in computing devices. The method comprises monitoring access requests between application and resources, building intrusion profiles based on monitoring observations, storing said profiles in a data repository, detecting application acts when applications are used, comparing acts to said profiles and based on comparison result performing a security action. Furthermore, suitable hardware and software implementations are disclosed.

### FIELD OF THE INVENTION

The invention relates to anomaly detection in computing devices.

### BACKGROUND OF THE INVENTION

Recently devices that are capable of executing downloadable computer programs have become popular and common. For example, mobile devices, such as mobile phones, are capable of executing computer programs. As the complexity of the devices increases when the user is able to execute different computer programs in the device, there is a need for securing fluent user experience. In addition to well designed software, an important feature is the security of the software. The user must be aware of the software installation and know if the software he/she is installing to the device is secure.

In order to improve the security special security functionality has been added to computing devices, such as mobile phones. A security element or a trusted platform controls access to sensitive programming interfaces and data. An example of access control is an access decision based on the validation of the signed capabilities and application code. However, these mechanisms work only if the signed application code can really be trusted. Furthermore, this mechanism cannot prevent bad implementation, such as buffer overflows, or viruses that sneaked in during application development.

### SUMMARY

The invention discloses an apparatus suitable for improving the application security comprising a processor for executing program code, a memory for storing intrusion profile data, and an anomaly detection component, which is configured to detect deviating access requests and to perform a security action if needed. Profiles are a collection of expected behaviour of an application on resource access and consumption based on previous or similar experience in the past. The collection of experience may have happened in the same node or in a different node. The profile can be assigned to an application and/or user. Furthermore, a profile can be assigned also to a group of applications and/or users. The anomaly detection component may be a software module or a hardware component supported by a software module. The security action may be an alarm, a notification or a denial of request. The apparatus further comprises an external communication connection for accessing external resources. The apparatus may be embodied, for example, to a mobile phone or other computing device, in which case the apparatus may utilize corresponding means of the host device. External communication connection may be a wireless data communication connection or a peripheral connection for a particular peripheral, or similar.

The invention is implemented by using apparatus described above or by implementing following method by using other equivalent means that are capable of executing the method. The equivalent means comprise specific hardware implementations and a software implementation. The software implementation may be implemented on a general purpose processor of the host device or it is possible to use programmable hardware solution, wherein a processor is arranged to execute the software module. The method comprises monitoring access requests between application and resources, building intrusion profiles based on monitoring observations, storing said profiles in a trusted data repository, detecting application acts when applications are used, comparing acts to said profiles and based on comparison result performing a security action. Building and storing profiles are cumulative processes that take existing profiles into account and experience. The security action comprises raising an alarm, which alarm is sent to the administrator and/or to the user of the device. A further example of a security action is a denial of the request. Additional security actions, such as granting limited access, or similar, may be introduced if needed.

In an embodiment the method further comprises predetermined profiles. The administrator or other service provider can produce predetermined profiles for different types of applications. For example, messaging, office, location and browsing applications have different types of acts. However, most of these acts are common for all users and it is possible to produce predetermined profile that is later updated according to the users needs.

The method described above may be implemented as a computer program embodied on a computer-readable medium comprising program code means adapted to perform the method when the program is executed in a computing device by using a processor or other execution means for executing the program code and a memory for storing the corresponding data.

Thus, the benefit of the invention is providing better application security for computing devices. The information provided by raised alarms gives the opportunity to counteract security breaches in a much more efficient manner. This increases the user comfort and reduces administration tasks and, thus, reduces administration costs.

### BRIEF DESCRIPTION OF THE DRAWINGS

The accompanying drawings, which are included to provide a further understanding of the invention and constitute a part of this specification, illustrate embodiments of the invention and together with the description help to explain the principles of the invention. In the drawings:

FIG. 1 is a diagram of an example embodiment of the present invention,

FIG. 2 is a flow chart of a method according to an example embodiment of the present invention,

FIG. 3 is a block diagram of an example embodiment according to the present invention.

### DETAILED DESCRIPTION OF THE INVENTION

Reference will now be made in detail to the embodiments of the present invention, examples of which are illustrated in the accompanying drawings.

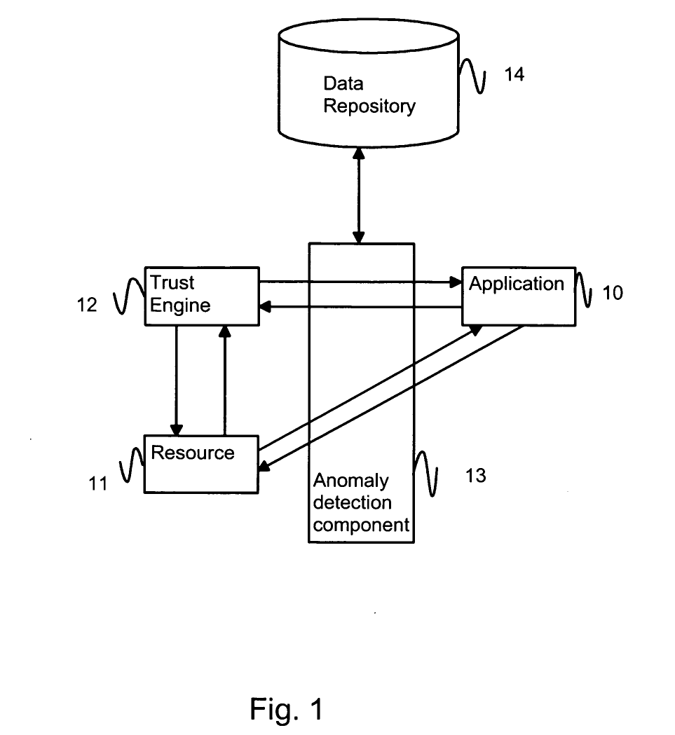

In FIG. 1 a diagram of an example embodiment of the present invention is disclosed. FIG. 1 discloses a basic setting in logical level, in which an application 10 is executed in a computing device, such as mobile communication device, ordinary computer or similar. Application 10 requests resources on a device from a trust engine 12 that is guarding resources 11 on the device. Resources may be files, peripheral devices, network connections, cryptographic keys, messaging capabilities or similar. Guarded resources 11 comprise all internal and external resources that are available to the application 10. The trust engine 12 verifies and identifies the application and determines if access can be granted to the requested resource. The trust engine 12 can either act as a gatekeeper through which all data transfer between the requesting application and the resource is tunneled or the trust engine 12 can be implemented as a security supervisor that grants application the necessary access credentials that the application then can use to obtain direct access to the resource. The trust engine can be provided, for example, by the operating system.

For improving the security the present invention implements an anomaly detection component 13 between the application 10 and the resources 11 and the trust engine 12. Thus, the anomaly detection component 13 guards all traffic that is between the application 10 and the resources 11 no matter how the resources 11 are addressed, however, the anomaly detection component 13 can be configured to cooperate with the trust engine 12. This is the case particularly when the resources 11 are distributed. The anomaly detection component 13 monitors all access requests and resource accesses issued by the applications. Based on the observations it builds intrusion profiles that describe how the applications request access to and use the resources. For example, an application may never request access to a phone book. The anomaly detection component 13 stores the profiles in a trusted persistent data repository 14. After a sufficient training period the profiles are used for detecting cases in which the application 10 acts maliciously or there is some other deviation that needs to be blocked. When a deviation is detected, the administrator and/or the user of the device will be informed.

The anomaly detection component 13 of FIG. 1 can be implemented as a hardware solution or as a software module. Both implementations have their benefits and the implementation must be considered with the overall design of the device to which the anomaly detection component 13 will be installed. The persistent data repository 14 is typically internal but it can be implemented also externally or on removable tokens like a smart card. However, a guaranteed access to the data repository is important. Thus, even if the data repository is external 14 to the anomaly detection component 13, it is usually internal to the device to which the anomaly detection component 13 is installed.

When the anomaly detection component 13 detects a deviation or a possible deviation, it can cooperate with the trust engine 12 so that the trust engine 12 analyzes the possible deviation. If it is likely that the deviation is a malicious act by a malicious program or an attacker, the trust engine 12 can restrict the use of the resources 11. The restriction can be temporary or permanent denial, an explicit user confirmation, a partial data release or other conditions. These restrictions are under may be determined by the administrator. The administrator can then decide if the act was malicious and it is possible to classify the act. Classified acts can be copied to other devices that are managed by the same administrator. Thus, when an attacker manages to attack to a device, the administrator can make a preventive act to protect the other devices. Furthermore, the administrator or other service provider can produce predetermined profiles for different types of applications. Or the user, administrator or service provider may assign a new application to a predetermined profile with similar behavior. For example, messaging, office, location and browsing applications have distinctive different types of acts. However, most of these acts are common for all users and it is possible to produce predetermined profile that is later updated according to the users needs.

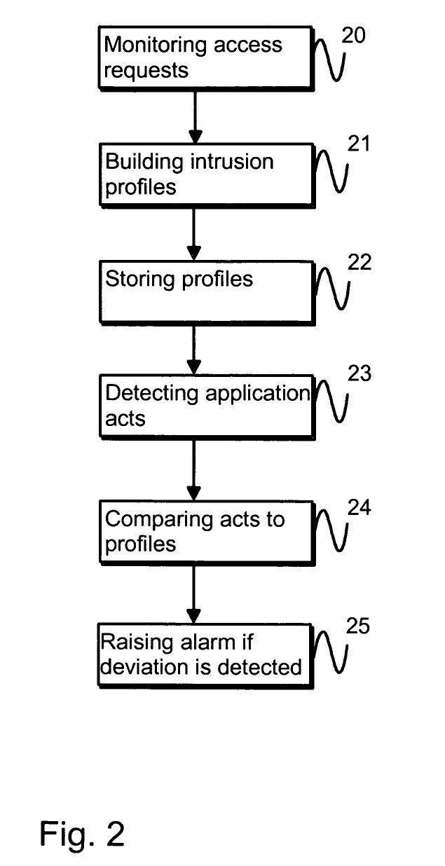

FIG. 2 is a flow chart of a method according to an example embodiment of the present invention. The method disclosed in FIG. 2 is implemented into anomaly detection component 13 of FIG. 1. The actual implementation of the method might be hardware or software based depending on the overall design of the client device. Thus, a hardware unit or a software module is arranged to execute the functionality of the method disclosed in FIG. 2. Even if the method in FIG. 2 is disclosed as a sequence of steps, a person skilled in the art understands that each of the steps may be executed concurrently. Furthermore, the client devices typically execute a plurality of software applications simultaneously. Thus, there is a continuous need for different steps with different data. For clarity reasons, only one application was disclosed in FIG. 1.

The method according to the present invention continuously monitors access requests issued by software applications, step 20. The access request are gathered for building intrusion profiles, step 21. These profiles may be continuously cumulatively rebuilt, updated and fine tuned for providing a better profile. The profiles are stored into a data repository for future use, step 22.

When the applications use resources, the anomaly detection component detects the acts, step 23. The acts may be any use of internal or external resources that need to be guarded. The detected acts are then compared with the previously stored profiles, step 24. If an unwanted deviation is detected in the comparison, an alarm will be raised, step 25. The alarm will be informed to the administrator of the device and possibly also to the user. In addition to the alarm the execution of a deviating act may be denied. The deviation may be initiated by a malicious application or user. For example, if the device is stolen, the thief might try to use the device differently. For example, sending classified documents without encryption might be a deviating act initiated by the user.

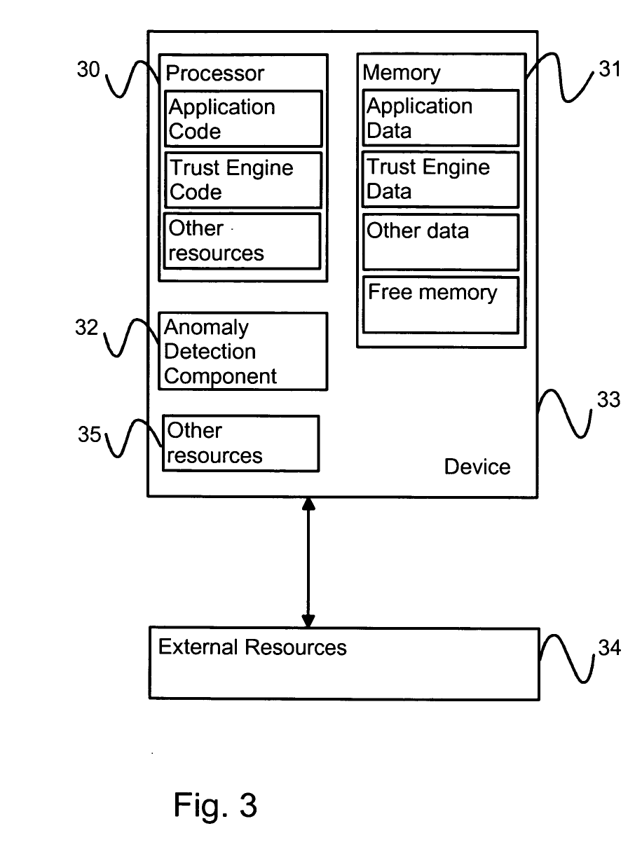

FIG. 3 is a diagram of an example embodiment of the present invention. In FIG. 3 a client device 33 and external resources 34 are disclosed. The client device 33 includes internal resources. The device 33 includes a processor 30, a memory 31 and an anomaly detection component 32 that interacts with a trust engine and other resources 35. Alternatively the anomaly detection component 32 may be implemented as a software module that is executed in the processor 30 and stored into memory 31. Additionally the device may comprise other resources, such as a display, keyboard, speaker, microphone, camera or other similar peripherals that are integrated to the device or connected to the device by wire or wirelessly. In the example of FIG. 3 the trust engine is implemented as a software module and the code is executed in the processor 30 and the data is stored into the memory 31. The client device 33 executes all program code in the processor 30 and stores all data in the memory 31. However, the present invention is not limited to this but the client device may include more than one processor and more than one different memories.

It is obvious to a person skilled in the art that with the advancement of technology, the basic idea of the invention may be implemented in various ways. The invention and its embodiments are thus not limited to the examples described above; instead they may vary within the scope of the claims.

1. A method comprising:
monitoring access requests;
building intrusion profiles from the access requests;
storing the intrusion profiles on a trusted platform;
detecting application acts;
comparing the application acts to said intrusion profiles; and
based on the comparing of the application acts, performing a security action.

2. The method according to claim 1, wherein performing the security action comprises sending a message to an administrator.

3. The method according to claim 2, wherein the message is further sent to a user.

4. The method according to claim 1, wherein performing the security action comprises performing a denial of request.

5. The method according to claim 2, the method further comprising requesting a response to said message.

6. An apparatus, comprising:
a processor configured to execute program code;
a memory in communication with the processor configured to store intrusion profile data; and
an anomaly detection component configured to detect deviating access requests and to perform a security action in response to the detecting.

7. The apparatus according to claim 6, wherein the anomaly detection component comprises a software module.

8. The apparatus according to claim 6, wherein the anomaly detection component comprises a hardware component.

9. The apparatus according to claim 6, wherein the security action comprises a message.

10. The apparatus according to claim 6, wherein the security action of the anomaly detection component further comprises a denial of request.

11. The apparatus according to claim 6, wherein the apparatus further comprises an external communication connection for accessing external resources.

12. An apparatus comprising:
executing means for executing program code;
storing means for storing intrusion profile data in communication with the execution means; and
detection means for anomaly detection in communication with the executing means, which is configured to detect deviating access requests and to perform a security action in response to a detecting.

13. The apparatus according to claim 12, wherein the detection means is implemented as a software module.

14. The apparatus according to claim 12, wherein the detection means comprising a hardware component.

15. The apparatus according to claim 12, wherein the security action of the detection means comprises an alarm.

16. The apparatus according to claim 12, wherein the security action comprises a denial of request.

17. The apparatus according to claim 12, wherein the apparatus further comprises an external communication connection for accessing external resources.

18. A computer program embodied on a computer-readable medium comprising program code means configured to control a computing device to perform following:
monitoring access requests;
building intrusion profiles based upon the monitored access requests;
storing the intrusion profiles;
detecting application acts;
comparing the detected application acts to said intrusion profiles; and
based on comparison result, performing a security action.

19. The computer program according to claim 18, wherein the performing the security action comprises raising an alarm, which alarm is sent to the administrator.

20. The computer program according to claim 19, wherein the alarm is further sent to the user.

21. The computer program according to claim 18, wherein the security action comprises a denial of the request.
